(19) United States
(12) Patent Application Publication
(10) Pub. No.: US 2008/0246713 A1
(43) Pub. Date: Oct. 9, 2008

(54) DISPLAY APPARATUS AND CONTROL METHOD THEREOF

(75) Inventors: Jun-Woo LEE, Anyang-si (KR); Hee-Seop KIM, Hwaseong-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/933,380

(22) Filed: Oct. 31, 2007

(30) Foreign Application Priority Data
Apr. 4, 2007 (KR) 10-2007-0033493

(51) Int. Cl. G09G 3/36

(52) U.S. Cl. 345/89; 345/87; 345/92

(57) ABSTRACT

A display apparatus includes a display panel that includes a plurality of pixels and a panel driver. The panel driver receives original image signals corresponding to successive frames which are displayed in a predetermined number within a predetermined period of time, forms an interpolation image signal on the basis of original image signals corresponding to two successive frames, and forms a non-image signal, and applies the original image signal, the interpolation image signal, and the non-image signal to the respective pixels during a display period.

### CROSS-REFERENCE TO RELATED APPLICATIONS

This application claims priority from and the benefit of Korean Patent Application No. 10-2007-0033493, filed on Apr. 4, 2007, which is hereby incorporated by reference for all purposes as if fully set forth herein.

### BACKGROUND OF INVENTION

1. Field of Invention

The present invention relates to a display apparatus and a control method thereof, more particularly, to a display apparatus with a high response speed and a control method thereof.

2. Discussion of the Background

A liquid crystal display (LCD), which is a widely used display apparatus, includes an LCD panel. The LCD panel includes a first substrate where thin film transistors (TFTs) are formed, a second substrate facing the first substrate, and a liquid crystal layer interposed between the first and second substrates. Since the LCD panel is not self-emissive, a backlight unit may be provided behind the first substrate to provide light to the LCD panel. Transmittance of light irradiated from the backlight unit is adjusted according to the alignment of the liquid crystals.

Since the LCD holds a voltage applied to a pixel during one frame, it may generate a blur, which is not formed in an impulsive-type display apparatus such as a cathode ray tube (CRT). The blur is generated more often in moving images and more serious in a larger-sized display apparatus since pixels are driven quickly.

In order to prevent a blur in a display apparatus and to improve visibility of moving images, a method of scanning light from the backlight unit and a driving method to increase a speed of applying an image signal from 60 Hz to 220 Hz or 180 Hz may be used. However, brightness may be decreased and flicker may be generated in the former method, and a charging rate may be reduced by a slow response speed of liquid crystals in the latter.

### SUMMARY OF THE INVENTION

The present invention provides a display apparatus that may have improved visibility of moving images and a control method thereof.

Additional aspects of the present invention will be set forth in part in the description which follows and, in part, will be obvious from the description, or may be learned by practice of the present invention.

The present invention discloses a display apparatus including a display panel that includes a plurality of pixels, and a panel driver. The panel driver receives original image signals corresponding to successive frames, forms an interpolation image signal on the basis of original image signals corresponding to two successive frames, and forms a non-image signal. The panel driver applies the original image signal, the interpolation image signal, and the non-image signal to the respective pixels during a display period of one frame.

The present invention also discloses a control method of a display apparatus that includes a display panel having a plurality of pixels. The method includes receiving original image signals corresponding to successive frames, forming an interpolation image signal on the basis of original signals corresponding to two successive frames, forming a non-image signal, and displaying an image signal where the original image signal, the interpolation image signal, and the non-image signal are applied to the respective pixels during a display period of one frame.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view of a display apparatus according to an exemplary embodiment of the present invention.

FIG. 2A and FIG. 2B show a pixel of the display apparatus of FIG. 1.

FIG. 3 shows a control method of the display apparatus of FIG. 1.

FIG. 4 shows a waveform of a signal to illustrate a control method of FIG. 3.

FIG. 5A and FIG. 5B show a display panel formed by the control method of FIG. 4.

FIG. 6 shows a brightness variation according to the control method of FIG. 4.

FIG. 7 is a flow chart showing the control method of FIG. 4.

FIG. 8A and FIG. 8B show another display panel formed by the control method of FIG. 4.

FIG. 9 shows a waveform of a signal to illustrate another control method according to an exemplary embodiment of the present invention.

FIG. 10 shows a brightness variation according to the control method of FIG. 9.

FIG. 11 shows a waveform of a signal to illustrate another control method according to an exemplary embodiment of the present invention.

FIG. 12A and FIG. 12B show a display panel formed by the control method of FIG. 1.

FIG. 13 shows a brightness variation according to the control method of FIG. 11.

FIG. 14 is a flow chart showing the control method of FIG. 11.

FIG. 15 is a schematic view of a display apparatus according to another exemplary embodiment of the present invention.

FIG. 16 shows a waveform of a signal to illustrate a control method of the display apparatus of FIG. 15.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

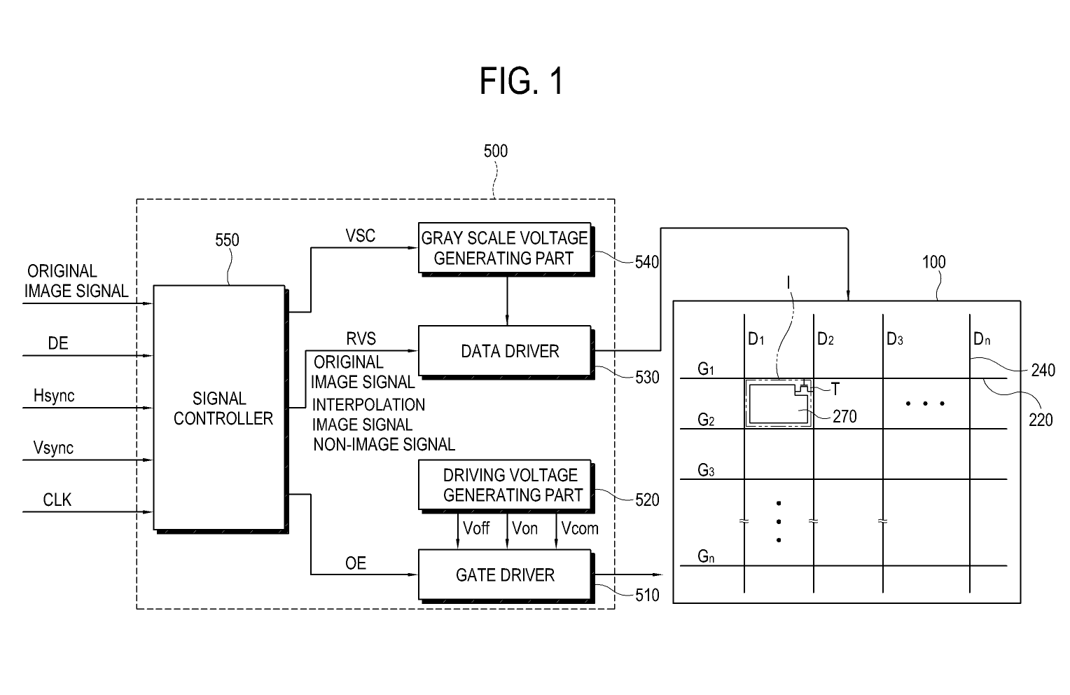

Referring to FIG. 1, a display apparatus according to an exemplary embodiment of the present invention includes a display panel 100 and a panel driver 500 to drive the display panel 100. A plurality of pixels I are arranged in a matrix on the display panel 100. One pixel I includes a gate line 220, a data line 240, a TFT T formed at a crossing area of the gate line 220 and the data line 240, and a pixel electrode 270 connected to the TFT T.

The panel driver 500 includes a gate driver 510, a driving voltage generating part 520, a data driver 530, a gray scale voltage generating part 540, and a signal controller 550 to control these elements. An image signal is generally input to the panel driver 500 with a specific frequency. That is, the panel driver 500 receives image signals corresponding to successive frames, processes them, and applies the processed image signals. A certain number of frames may be displayed within a predetermined period of time.

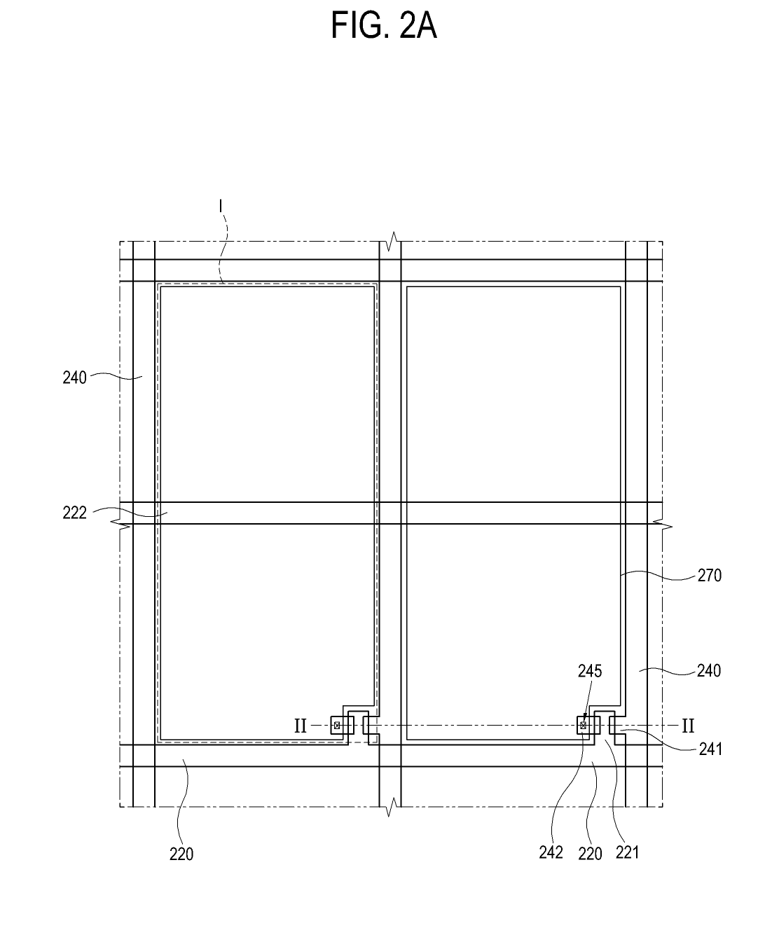

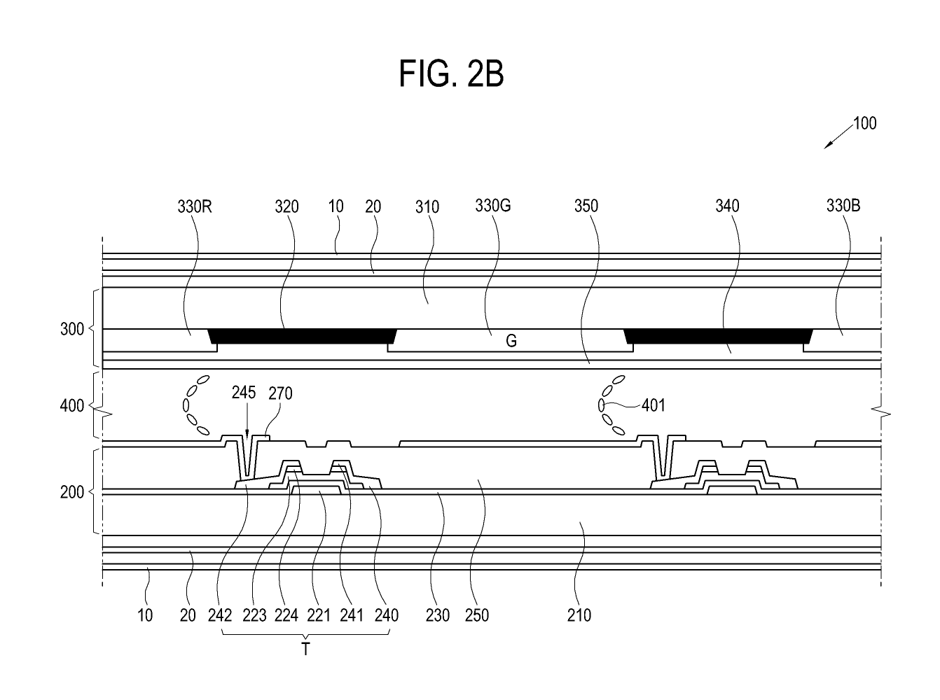

The display panel 100 will be described below with reference to FIG. 2. In the present exemplary embodiment, because the display panel 100 includes an LCD panel, the display apparatus is described with an LCD as an example. However, exemplary embodiments of the present invention may be used in other types of display apparatuses provided the other types of display apparatuses include a TFT substrate to form pixels I and a panel driver to drive a display panel. For example, the display apparatus may be an organic light emitting diode (OLED) display, which includes an organic light emitting layer. FIG. 2A is a plan view of the display panel of FIG. 1, and FIG. 2B is a cross-sectional view taken along line II-II in FIG. 2A.

Referring to FIG. 2A and FIG. 2B, a gate wiring 220, 221, and 222 is formed on a first insulating substrate 210. The gate wiring 220, 221, and 222 may include single or multiple metal layers. The gate wiring 220, 221, and 222 includes the gate line 220 extending transversely, a gate electrode 221 connected to the gate line 220, and a gate pad (not shown) connected to the gate driver 510 to receive a driving signal. Further, a storage electrode 222 is formed in the same layer as the gate line 220 and the gate electrode 221 to be charged with an electric charge.

A gate insulating layer 230, which may be made of silicon nitride (SiNx) or the like, is formed on the first insulating substrate 210 to cover the gate wiring 220, 221, and 222.

A semiconductor layer 223, which may be made of amorphous silicon, is formed on the gate insulating layer 230 over the gate electrode 221. An ohmic contact layer 224, which may be made of n+ hydrogenated amorphous silicon highly doped with silicide or n-type impurities, is formed on the semiconductor layer 223. The ohmic contact layer 224 is not arranged in a channel area between a source electrode 241 and a drain electrode 242.

A data wiring 240, 241, and 242 is formed on the ohmic contact layer 224 and the gate insulating layer 230. The data wiring 240, 241, and 242 may include single or multiple metal layers. The data wiring 240, 241, and 242 includes the data line 240, which is formed lengthwise to cross with the gate line 220 to form a pixel I, the source electrode 241 branched from the data line 240 to extend over the ohmic contact layer 224, and the drain electrode 242, which is spaced apart from the source electrode 241 and formed on a portion of the ohmic contact layer 224 opposite to the source electrode 241.

A passivation layer 250 is formed on the data wiring 240, 241, and 242 and a portion of the semiconductor layer 223 that is not covered with the data wiring 240, 241, and 242. Here, an inorganic insulating layer of silicon nitride may also be formed between the passivation layer 250 and the TFT T in order to improve reliability of the TFT T.

The pixel electrode 270 may be made of a transparent conductive material such as indium tin oxide (ITO) or indium zinc oxide (IZO) and formed on the passivation layer 250. The pixel electrode 270 is connected to the drain electrode 242 through a contact hole 245.

Next, a second substrate 300 will be described below.

A black matrix 320 is formed on a second insulating substrate 310 at a position corresponding to the TFT T of the first substrate 200. The black matrix 320 is disposed between red, green, and blue color filters to divide the color filters, and it prevents light from being irradiated directly to the TFT T. The black matrix 320 may be made of a photoresist organic material including a black pigment. The black pigment may be carbon black, titanium oxide, or the like.

A color filter layer 330 includes red (R), green (G), and blue (B) color filters 330R, 330G, and 330B, which are alternately disposed and separated by the black matrix 320. The color filter layer 330 allows light irradiated from a backlight unit (not shown) and passing through the liquid crystal layer 400 to be displayed as colored light. The color filter layer 330 may be made of an organic photoresist material.

An overcoat layer 340 is formed on the color filter layer 330 and the black matrix 320. The overcoat layer 340 provides a planar surface and protects the color filter layer 330. The overcoat layer 340 may be made of an acrylic epoxy material.

A common electrode 350 is formed on the overcoat layer 340. The common electrode 350 may be made of a transparent conductive material such as ITO or IZO. The common electrode 350 applies a voltage directly to the liquid crystal layer 400 along with the pixel electrode 270 of the first substrate 200.

The liquid crystal layer 400 is disposed between the first substrate 200 and the second substrate 300. The two substrates 200 and 300 are bonded by a sealant (not shown). The liquid crystal layer 400 includes a plurality of liquid crystal molecules 401, which change their orientation depending on an applied voltage. In the present exemplary embodiment, the liquid crystal molecules 401 are aligned in an optically compensated birefrigency (OCB) mode. The nematic liquid crystal molecules are aligned in a splay state and applied with a predetermined voltage to be aligned in a bend state, thereby controlling light transmittance by adjusting the applied voltage. The OCB-mode liquid crystal molecules 401 may provide for a fast response time and wide viewing angle. The display apparatus according to an exemplary embodiment of the present invention forms a plurality of sub-frames during a period of time in which one frame is formed in a conventional display apparatus. Thus, the display apparatus including the liquid crystal layer 400 should have high response speed. Because liquid crystal molecules 401 aligned in the OCB mode may reach 3 to 4 ms in response speed, they may be used in a display apparatus according to exemplary embodiments of the present invention. The display apparatus may be a vertically aligned (VA) mode, a patterned VA mode, or a super patterned VA mode.

The display apparatus further includes compensation films 20 provided outside each of the first substrate 200 and the second substrate 300 and polarizing films 10 disposed outside the compensation films 20. The polarizing films 10 are disposed with their polarizing axes perpendicular to each other, and form an angle of 45 degrees or 135 degrees with an alignment film (not shown) in its rubbing direction.

Returning to FIG. 1, the panel driver 500 will be described below.

The driving voltage generating part 520 generates a gate-on voltage Von to turn on the TFT T, a gate-off voltage Voff to turn off the TFT T, a common voltage Vcom applied to the common electrode 350, etc.

The gray scale voltage generating part 540 generates a plurality of gray scale voltages, which are related to brightness of the display apparatus.

The gate driver 510 is referred to as a scan driver and is connected to the gate line 220 to apply a gate signal such as a gate-on voltage Von and a gate-off voltage Voff to the gate line 220.

The data driver 530 is referred to as a source driver. The data driver 530 receives gray scale voltages from the gray scale voltage generating part 540, selects a gray scale voltage according to control by the signal controller 550, and applies the selected gray scale voltage as a data voltage to the data line 240.

The signal controller 550 receives image signals corresponding to successive frames, which are each displayed by a plurality of sub-frames during a unit of time, and a control signal and provides them to respective components. The signal controller 550 also forms an interpolation image signal, which is based on an image signal corresponding to two successive frames, and a non-image signal. Hereinafter, an image signal, which is originally input but not processed, will be referred to as an original image signal to be distinguished from the interpolation image signal. The signal controller 550 receives RGB gray signals corresponding to an original image signal and an input control signal to control display of the RGB signals from a graphic controller. Here, the input control signal, for example, includes a vertical synchronizing signal Vsync, a horizontal synchronizing signal Hsync, a main clock CLK, a data enable signal DE, etc. The signal controller 550 generates a gate control signal, a data control signal, and a voltage selection control signal VSC on the basis of the input control signal. The signal controller 550 transmits the gate control signal to the gate driver 510, the data control signal, the original image signal, the interpolation image signal, and the non-image signal to the data driver 530, and the voltage selection control signal VSC to the gray scale voltage generating part 540.

The gate control signal includes a vertical synchronization start signal STV, which directs to start outputting a gate on pulse (a high level range of a gate signal), a gate clock signal to control an output time of the gate on pulse, a gate on enable signal OE to determine a width of the gate on pulse, and the like. The data control signal includes a horizontal synchronization start signal STH, which indicates to start inputting a gray scale signal, a load signal LOAD or TP, which indicates to apply a data signal to data line 240, a reverse control signal RVS to change a polarity of a data signal, a data clock signal HCLK, and the like.

The signal controller 550 determines a proportion of an original image signal, an interpolation image signal, and a non-image signal. The signal controller 550 controls the gate driver 510 and the data driver 530 to apply the original image signal, the interpolation image signal, and the non-image signal according to the proportion determined for each of the pixels I during a display period T. The display period T refers to a time in which one frame is displayed. For example, if a 60 Hz image signal is input to the signal controller 550, the display period during which one frame is displayed on the display panel 100 is 1/60 seconds. The signal controller 550 receives an original image signal, forms an interpolation image signal on the basis of the original image signal, and displays the original image signal, an interpolation image signal, and a non-image signal in the respective pixels I during the display period, i.e., 1/60 seconds. As three different signals are applied to the pixels I for 1/60 seconds, the effect is that the pixels I are driven by 180 Hz. An interpolation image signal in the present exemplary embodiment is an image signal that has a middle value of a gray scale between gray scale values of original image signals of two successive frames. The middle value of the gray scale does not necessarily refer to an average value but indicates a value between the gray scale values of the two image signals. Further, if the gray scales of the original image signals of the two frames are the same, the interpolation image signal may be the same as the original image signals. The signal controller 550 may include an additional signal generating part that stores input image signals of successive frames and generates an interpolation image signal with a gray scale value between gray scale values of the image signals. Here, the additional signal generating part may be provided as a separate chip or the like. A non-image signal is a data voltage that has low transmittance and includes a black voltage or a gray voltage. The display apparatus may operate in an impulsive driving method using a black or gray voltage applied as a non-image signal, thereby reducing a blur of moving images and improving visibility thereof.

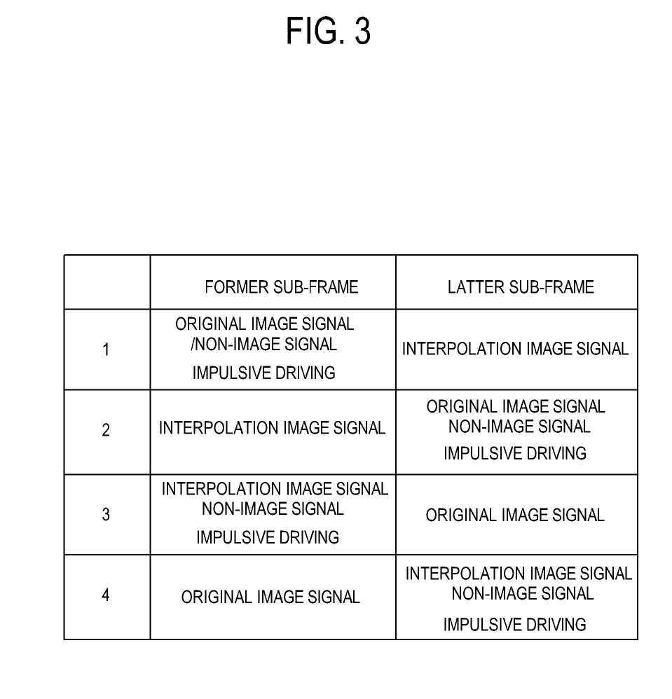

FIG. 3 illustrates a control method of the display apparatus of FIG. 1. The signal controller 550 forms two sub-frames during one display period to apply three different image signals to the pixels I. In the present exemplary embodiment, a sub-frame indicates an image which is formed during a time from when a gate line 220 applied with a gate signal starts to be scanned by a vertical synchronization start signal until when all gate lines 220 are sequentially scanned. Of the two sub-frame types formed by the signal controller 550, a first type of sub-frame displays one of an original image signal and an interpolation image signal and a second type of sub-frame displays the other of the original image signal and the interpolation image signal and a non-image signal. In order to form the second type of sub-frame, the display apparatus operates in an impulsive driving method where one of an original image signal and an interpolation image signal and a non-image signal are simultaneously displayed. In the impulsive driving method, a gate signal is simultaneously output to two gate lines 220, an image signal is applied to one gate lines 220, and a non-image signal such as a black signal is applied to the other gate line 220. FIG. 3 shows four cases for forming the first type sub-frame and the second type sub-frame during the display period. In the first case, a former sub-frame, which is formed first, is a second type sub-frame that is displayed with an original image signal and a non-image signal in an impulsive driving method, and a latter sub-frame, which is formed later, is a first type sub-frame that is displayed with an interpolation image signal. In the second case, the first type sub-frame of the first case is formed first, and the second-type sub-frame of the first case is formed later. Further, in the third and fourth cases, the second type sub-frame is displayed with an interpolation image signal and a non-image signal in an impulsive driving method, and a first type sub-frame is displayed with an original image signal.

To sum up, an original image signal or an interpolation image signal may be applied along with a non-image signal in an impulsive driving method, and the first type sub-frame and the second type sub-frame may be displayed in any order.

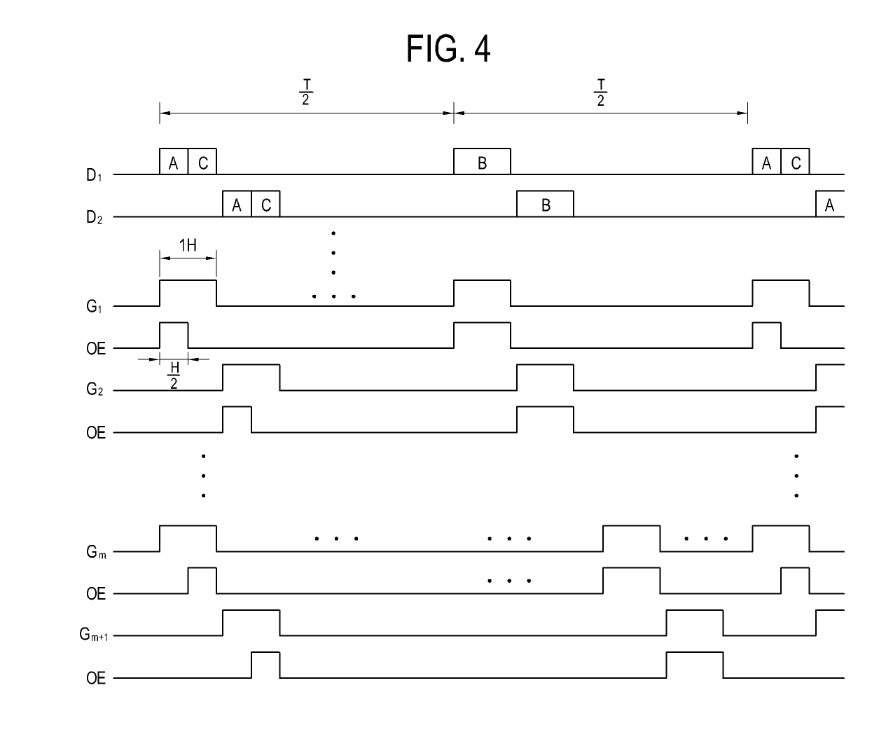

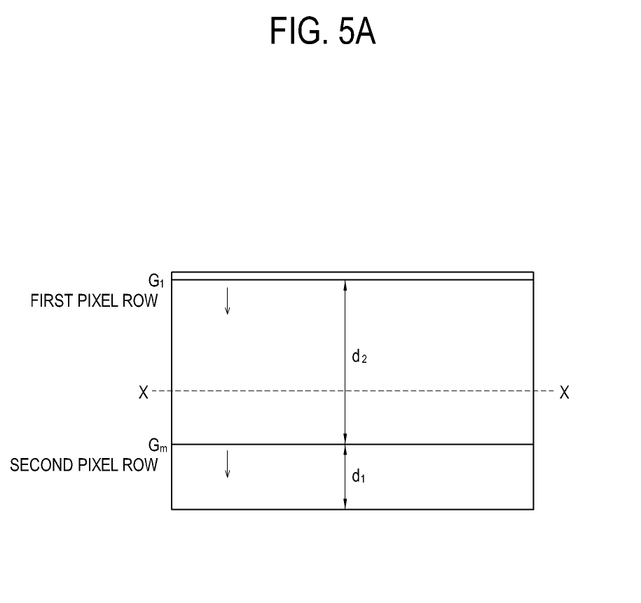

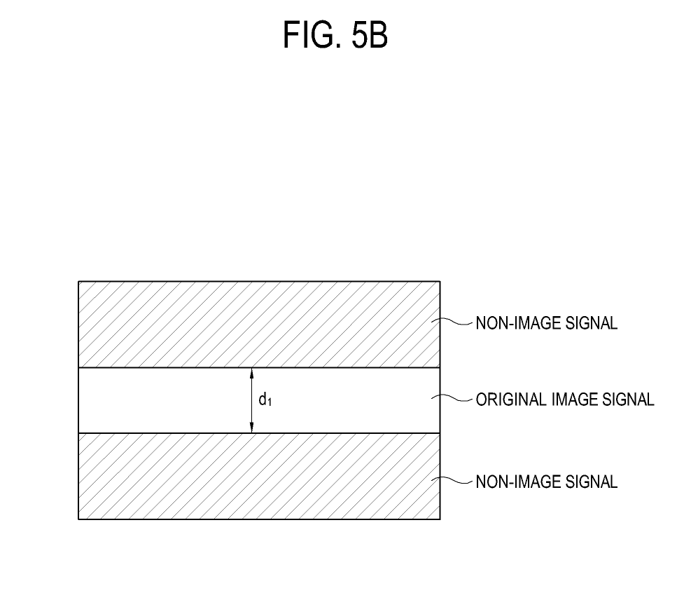

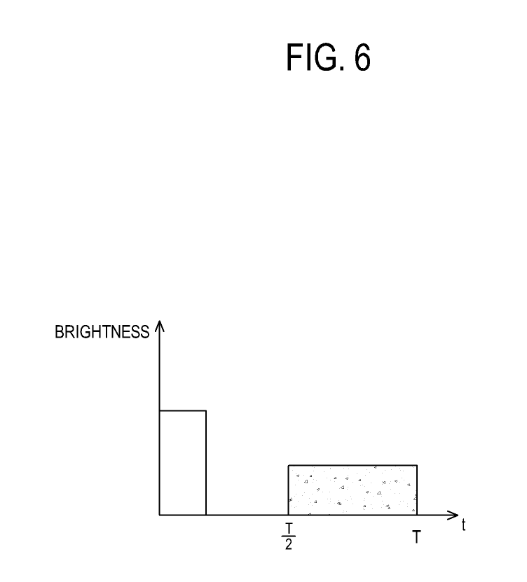

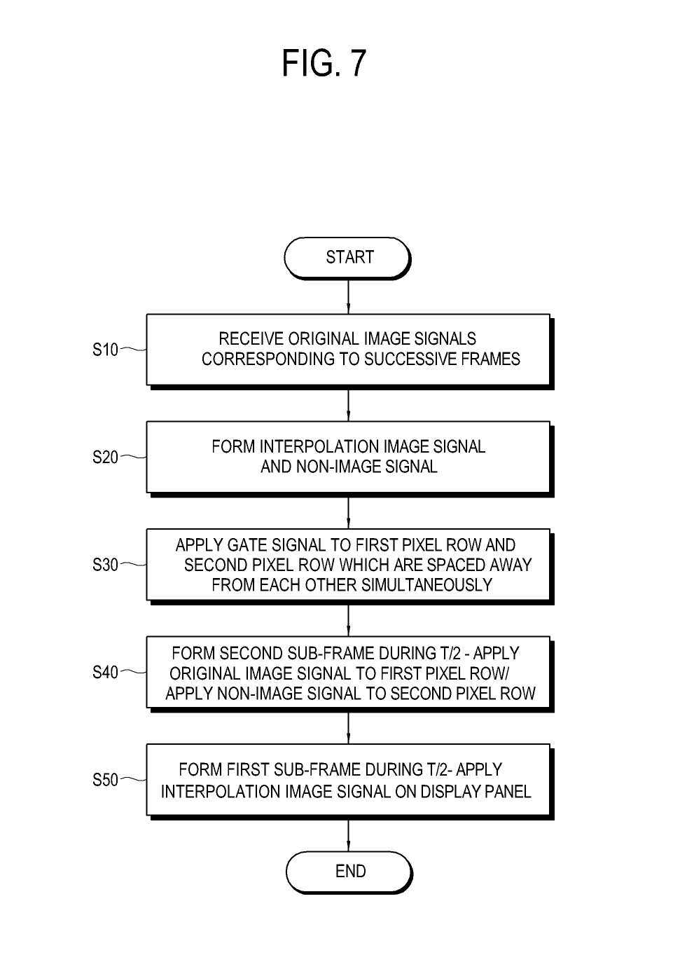

A control method according to the first case in FIG. 3 will be described below with reference to FIG. 4, FIG. 5A, FIG. 5B, FIG. 6, and FIG. 7. FIG. 4 shows a waveform of a signal, FIG. 5A and FIG. 5B show a display panel formed by the method of FIG. 4, FIG. 6 shows a brightness variation in the pixels I, and FIG. 7 is a flow chart to illustrate the control method of the first case of FIG. 3.

Referring to FIG. 4, FIG. 5A, FIG. 5B, FIG. 6, and FIG. 7, the second type sub-frame is first displayed on the display panel 100 during the first period of T/2, (i.e., the first half of the display period T), and the first type sub-frame is displayed during the second period of T/2 (i.e., the second half of the display period T). Here, the first type sub-frame and the second type sub-frame are formed for the same period of time. During the second type sub-frame, a gate signal is simultaneously applied to a first pixel row and a second pixel row, which are spaced apart from each other, an original image signal is displayed in the first pixel row, and a non-image signal is displayed in the second pixel row. Referring to FIG. 5A, thus, the gate driver 510 simultaneously applies a gate signal to a first gate line G1, which is connected to the first pixel row, and to an m-th gate line Gm, which is connected to the second pixel row, and the signal controller 550 outputs a gate enable signal OE, which activates the simultaneously applied gate signals in different periods of time, to the gate driver 510. Namely, as FIG. 4 shows, the first gate line G1 is activated during the first H/2 period of 1H corresponding to a gate signal on period, and the m-th gate line Gm is activated during the second H/2 period. During 1H in which the gate signal is applied to the first gate line G1 and the m-th gate line Gm, the data driver 530 sequentially outputs an original image signal A and a non-image signal C. The original image signal A and the non-image signal C are applied to different pixel rows according to the gate enable signal OE, respectively. Here, the original image signal A is applied to the first pixel row (i.e. first gate line G1) during the first H/2 period, and the non-image signal C is applied to the second pixel row (i.e. m-th gate line Gm) during the second H/2 period. Then, a gate signal is applied to a second gate line G2 and a (m+1)-th gate line Gm+1, and then a gate signal is sequentially applied to next gate lines.

In an impulsive driving method, an interval between the first pixel row and the second pixel row, which simultaneously receive the gate on signal, may be modified, thereby adjusting the proportions of the original image signal and the non-image signal during the second type sub-frame. Referring to FIG. 5A, as an interval between the first gate line G1 and the m-th gate line Gm increases, an area where the non-image signal is displayed on the display panel 100 increases. Because the m-th gate line Gm is disposed below the centerline X-X of the display panel 100 in a direction of a longer side, the interval d1 between the m-th gate line Gm and a last gate line is shorter than the interval d2 between the first gate line G1 and the m-th gate line Gm. The non-image signal is displayed on from the m-th gate line Gm to the last gate line, and then applied to the first gate line G1. Thus, referring to FIG. 5B, an area where the original image signal is displayed on the display panel 100 corresponds to the first interval d1 between the m-th gate line Gm and the last gate line. In brief, while the second type sub-frame is formed, the original image signal is scanned on the display panel 100 with the first interval d1 being maintained and the non-image signal such as a black voltage is displayed in the rest area where the original image signal is not displayed. Thus, an area where the non-image signal is displayed is larger than an area where the original image signal is displayed. As the area where the non-image signal is displayed increases, a period of time in which the non-image signal is applied to one pixel I during the second type sub-frame increases. Thus, the impulsive driving may be improved in its efficiency.

Applying the non-image signal to the first gate line G1 and the original image signal to the m-th gate line Gm provides an opposite result to the foregoing. In other words, the non-image signal is scanned on the display panel 100 with the first interval d1 being maintained.

After the second type sub-frame is formed first, the first type sub-frame, which is displayed with the interpolation image signal B, is formed during the later T/2 period. A gate signal is sequentially applied from the first gate line G 1 to the last gate line while the first type sub-frame is formed.

FIG. 6 illustrates brightness of the pixel I in the first pixel row, in which the highest brightness is shown during a part of first T/2 where the original image signal is applied while the second type sub-frame is formed, and then brightness is drastically decreased by the non-image signal such as a black signal. Then, brightness is increased by the interpolation image signal, which has a lower gray scale than the original image signal during the later T/2 period. The interpolation image signal may have a lower gray scale than the original image signal as one in the present exemplary embodiment or a higher gray scale. Further, if original image signals of successive frames have the same gray scale, brightness by the interpolation image signal may be the same as brightness by the original image signals.

Referring to FIG. 7, the control method according to the present exemplary embodiment is summarized below.

First, the signal controller 550 receives original image signals corresponding to successive frames (S10).

Then, the signal controller 550 forms an interpolation image signal on the basis of the original image signals corresponding to the two successive frames and a non-image signal corresponding to a black or gray voltage (S20). Generally, the interpolation image signal includes an image signal that has a gray scale between gray scales of the original image signals and may be formed by various known methods or other suitable alternatives.

The signal controller 550 forms two sub-frames during a display period T where a frame is displayed. While a former sub-frame is formed, the gate driver 510 simultaneously applies a gate signal to the first pixel row and the second pixel row, which are spaced apart from each other, to apply an impulsive driving method (S30). Further, the signal controller 550 outputs a gate enable signal OE to activate the simultaneously applied gate signals in different periods of time.

An original image signal A output from the data driver 530 is applied to the first pixel row, and a non-image signal C is applied to the second pixel row, thereby forming the second type sub-frame during the first T/2 period.

Finally, an interpolation image signal is applied to the display panel 100 during the remaining T/2 of the display period T, thereby forming the first type sub-frame (S50).

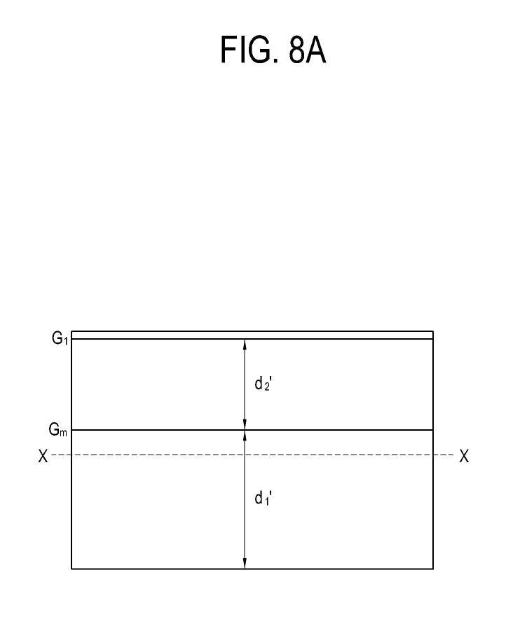

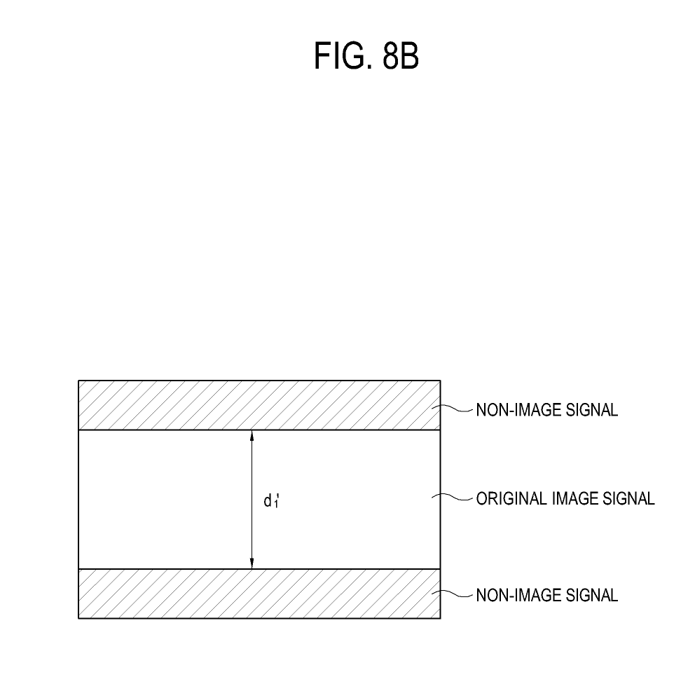

FIG. 8A and FIG. 8B show another display panel formed by the control method of FIG. 4 The m-th gate line Gm, which is applied with a gate signal at the same time as the first gate line G1, is disposed above the centerline X-X of the display panel 100 in a direction of a longer side. Thus, as an interval d2′ in which a non-image signal is formed is shorter than an interval d1′ in which an original image signal is formed, the original image signal is applied for a longer period of time than the non-image signal during the second type sub-frame in the present exemplary embodiment. The original image signal is scanned with the first interval d1′. Thus, a period of time in which the non-image signal is applied may be modified by selecting a position of the m-th gate line Gm. If the non-image signal is increased, visibility of moving images is improved by the impulsive driving, but transmittance may be reduced. Thus, a proportion of the non-image signal may be modified to satisfy optimal transmittance and visibility considering the size of the display panel 100 and characteristics of image signals.

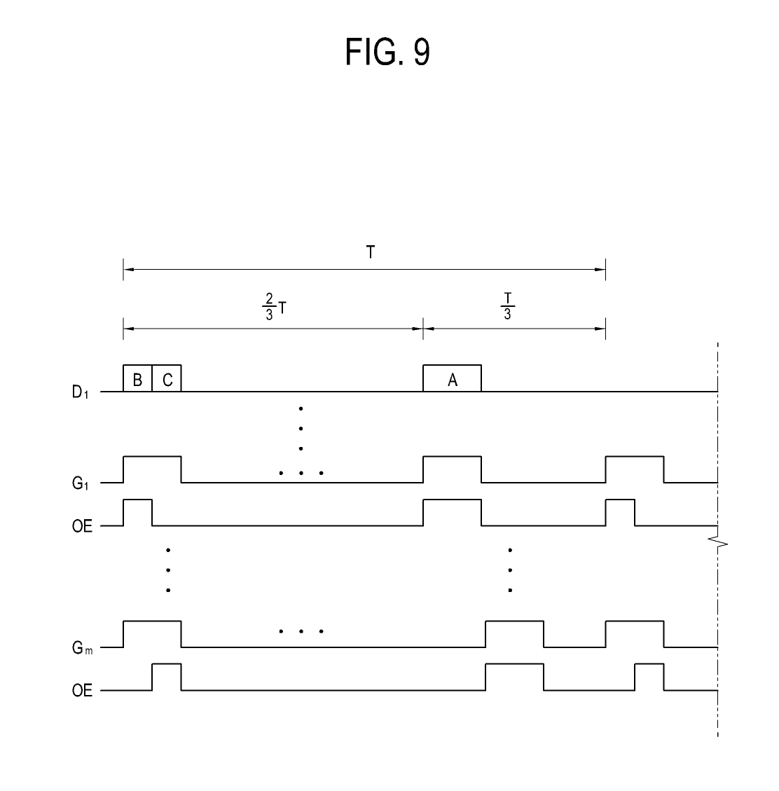

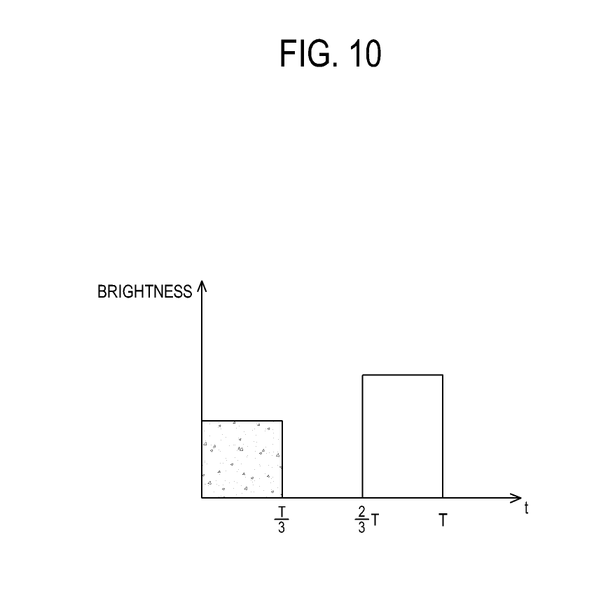

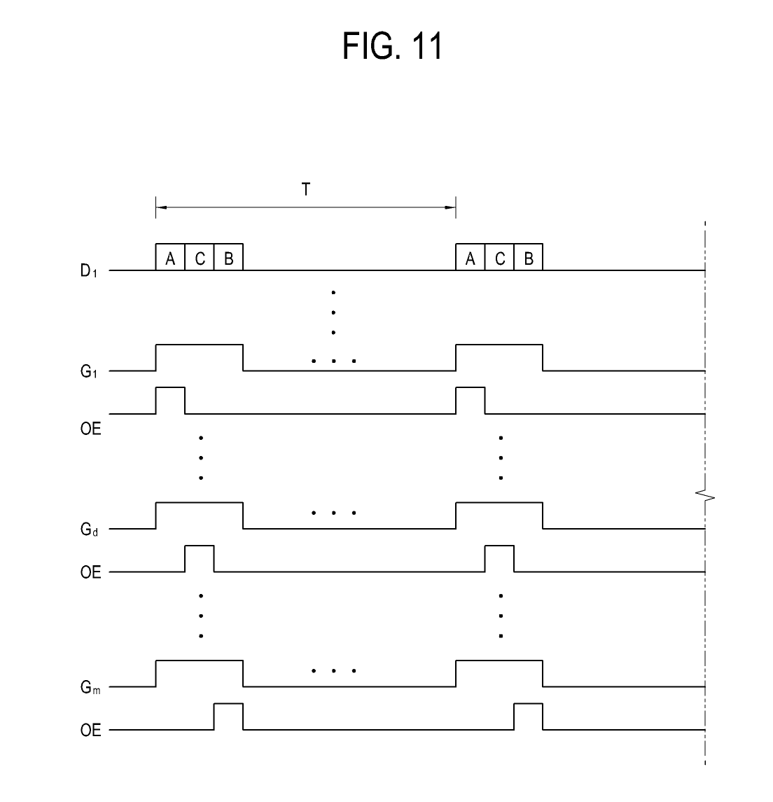

FIG. 9 shows a waveform of a signal to illustrate another control method according to an exemplary embodiment of the display apparatus in FIG. 1, and FIG. 10 shows a brightness variation according to the control method of FIG. 9. The present exemplary embodiment corresponds to the third case of FIG. 3. That is, the former sub-frame is formed by an impulsive driving method using an interpolation image signal B and a non-image signal C as the second type sub-frame, and the latter sub-frame is formed with an original image signal A as the first type sub-frame.

Referring to FIG. 9 and FIG. 10, the second type sub-frame is formed during two-thirds of the display period T, i.e., 2T/3, and the first type sub-frame is formed during T/3. That is, unlike in FIG. 4, the first type sub-frame and the second type sub-frame are formed for different periods of time. The second type sub-frame, which displays two kinds of image signals, is formed for a longer period of time than the first type sub-frame, which displays one image signal. Periods of time to form the sub-frames may be modified by adjusting a vertical synchronization start signal output from the signal controller 550 to the gate driver 510.

FIG. 10 illustrates brightness of the pixel I in the first pixel row, where the second type sub-frame is formed during the first 2T/3 of period T and the first type sub-frame is formed during the latter T/3 of period T. Brightness by the interpolation image signal is shown during the half of 2T/3, i.e., T/3, in which the second type sub-frame is formed, and brightness by the non-image signal is shown during the remaining T/3 period of the initial 2T/3 period. Thus, a charging time to apply the interpolation image signal to the pixel I may be sufficiently obtained, thereby improving a response speed of the liquid crystal molecules.

Periods of time to form the first and second sub-frames are not limited to those illustrated in FIG. 4 and FIG. 10, but may be modified variously depending on a response speed of the liquid crystal molecules.

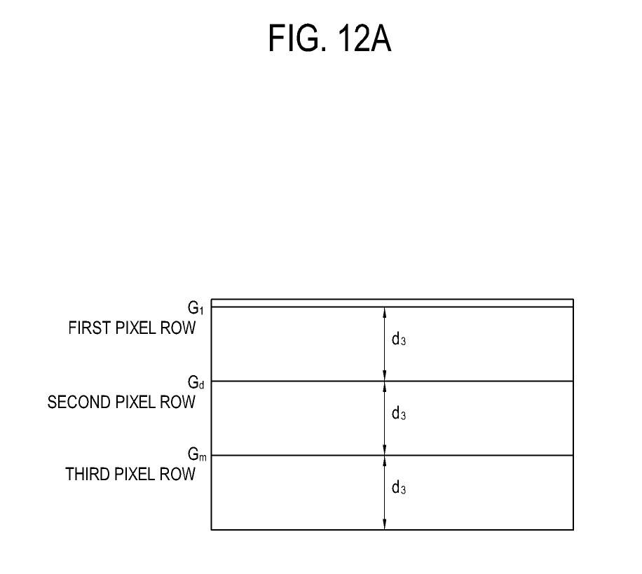

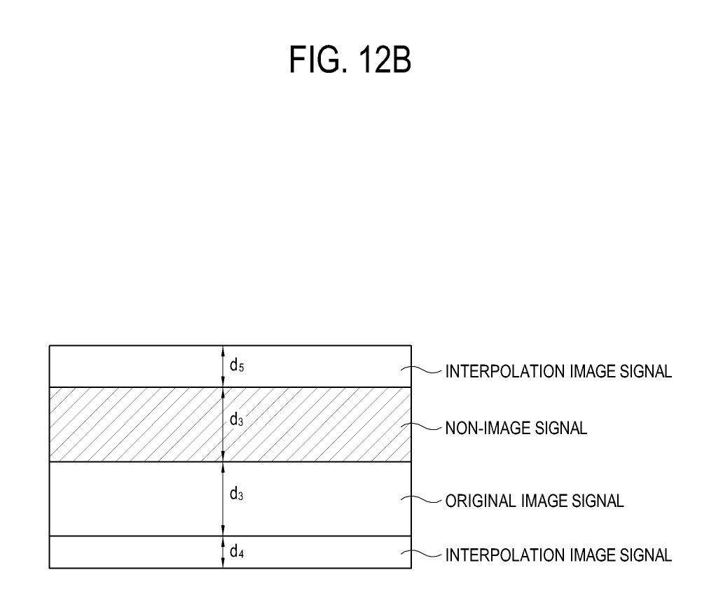

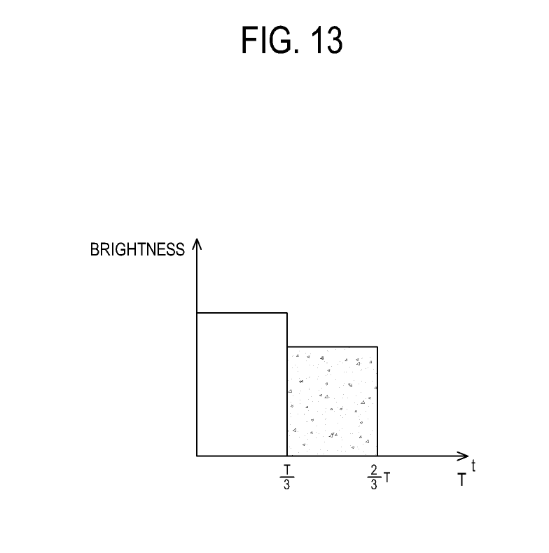

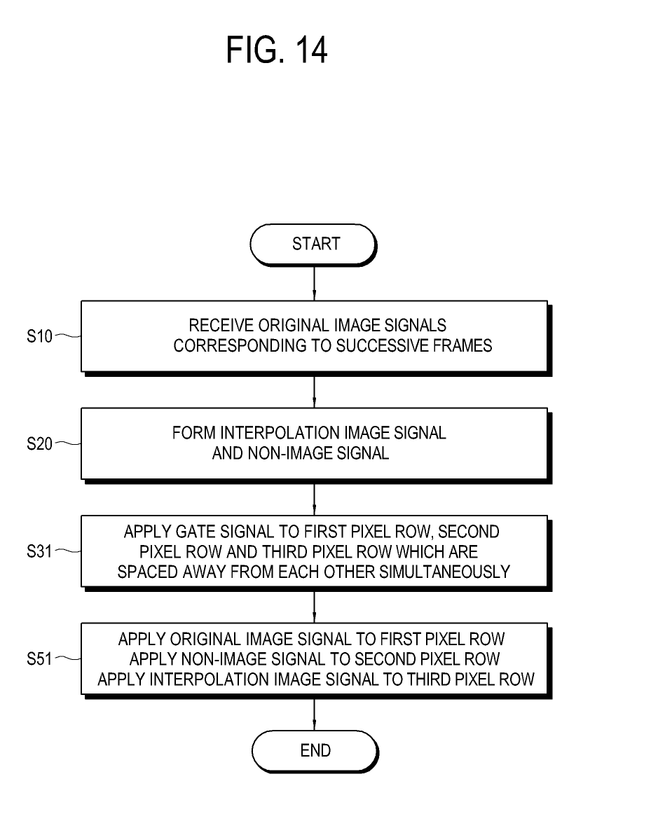

FIG. 1 shows a waveform of a signal to illustrate another control method according to an exemplary embodiment of the display apparatus in FIG. 1, FIG. 12A and FIG. 12B show a display panel formed by the control method of FIG. 1, FIG. 13 shows a brightness variation according to the control method of FIG. 1, and FIG. 14 is a flow chart showing the control method of FIG. 1.

The signal controller 550 displays one frame on the display panel 100 during the display period T. However, the signal controller 550 controls the gate driver 510 to simultaneously apply a gate signal to the first pixel row, the second pixel row, and a third pixel row, which are spaced apart from each other, during the frame, and controls a gate enable signal OE so that the gate signals are not activated at the same time. That is, the gate driver 510 simultaneously applies a gate signal to the gate lines G1, Gd, and Gm, which are connected to the first pixel row, the second pixel row, and the third pixel row, respectively. Accordingly, three different image signals, which are an original image signal, an interpolation image signal, and a non-image signal, are applied to different positions in the display panel 100 and scanned in an extending direction of the data line 240, respectively. The original image signal A is applied to the pixel I while the first gate line G1 is activated, the non-image signal C is applied to the pixel I while the d-th gate line Gd is activated, and an interpolation image signal B is applied to the pixel I while the m-th gate line Gm is activated. It should be noted that the image signals may be applied to the gate lines G1, Gd, and Gm regardless of their kinds.

Referring to FIG. 12A, regular intervals d3 exist between the gate lines G1, Gd, and Gm, which are applied with the gate signal at the same time. Referring to FIG. 12B, the image signals are displayed on the display panel 100 with the same size as time passes. Intervals d4 and d5 of the area where the interpolation image signal is displayed are separately disposed on the display panel 100, but the area has the same size as each of the areas where the original image signal and the non-image signal are displayed.

FIG. 13 illustrate brightness of the pixel I in a pixel row connected to the first gate line G1, where brightness by the original image signal is shown during first T/3, brightness by the interpolation image signal is shown between T/3 and 2T/3, and black brightness by the non-image signal is shown during the remaining T/3. The image signals are sequentially applied to the pixel row connected to the first gate line G1 in order of the original image signal, the interpolation image signal, and the non-image signal, but to a pixel row connected to the d-th gate line Gd in order of the non-image signal, the original image signal, and the interpolation image signal.

Intervals between the gate lines G1, Gd, and Gm, which simultaneously receive the same gate signal, may be modified as well. Thus, it is possible to increase the area where the non-image signal is displayed or decrease the area where the interpolation image signal is displayed.

According to the present exemplary embodiment, as three different signals are applied to each pixel I while one frame is formed, the pixel I is, in effect, driven by 180 Hz.

Referring to FIG. 14, the control method according to the present exemplary embodiment is summarized below.

First, the signal controller 550 receives original image signals corresponding to successive frames (S10).

Then, the signal controller 550 forms an interpolation image signal on the basis of the original image signals corresponding to the two successive frames and a non-image signal corresponding to a black or gray voltage (S20).

The signal controller 550 forms one frame during a display period T where a frame is displayed. While the frame is formed, the gate driver 510 simultaneously applies a gate signal to the first pixel row, the second pixel row, and the third pixel row, so as to apply an impulsive driving method (S3 1).

Further, the signal controller 550 outputs a gate enable signal OE to activate the gate signals, which are applied at the same time, in different periods of time.

Then, the signal controller 550 applies the original image signal to the first pixel row, the non-image signal to the second pixel row, and the interpolation image signal to the third pixel row, thereby displaying three different image signals in the pixel I during the display period T (S51).

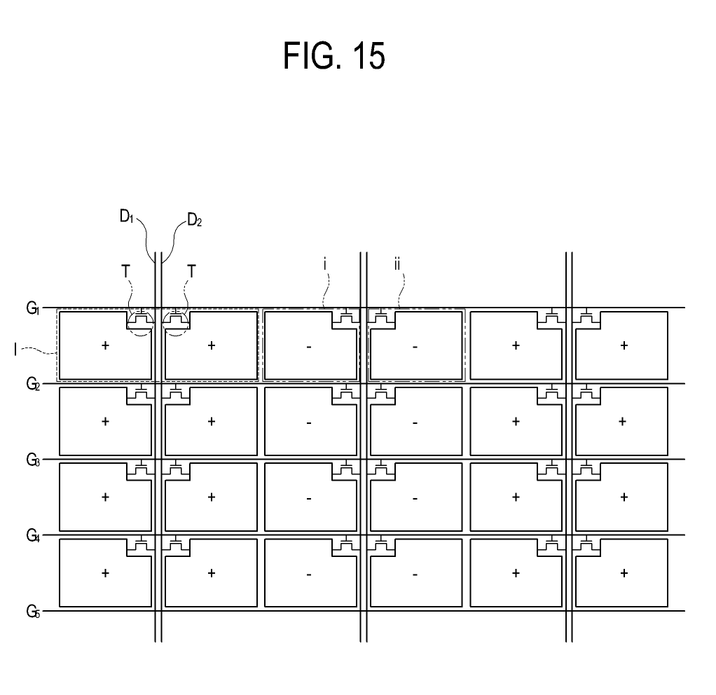

FIG. 15 is a schematic view of a display apparatus according to another exemplary embodiment of the present invention. In the display apparatus of FIG. 15, one pixel I includes two sub-pixels i and ii. When applied with a gate signal through a gate line G, the sub-pixels i and ii are applied with different data voltages. Accordingly, visibility of the display apparatus from a lateral side and a contrast ratio thereof may be improved by dividing a pixel into two sub-pixels and adjusting transmittances of the sub-pixels to be different.

In the present exemplary embodiment, a data driver applies a data voltage with the same polarity to neighboring pixels I in a column direction. Such an inversion type driving method is referred to as vertical inversion driving or column inversion driving, where neighboring pixels I in a row direction are applied with different polarity data voltages. While one frame is formed, the data voltage with the same polarity is applied to the neighboring pixels in the column direction, thereby increasing a charging rate. That is, the display apparatus according to the present exemplary embodiment may adopt the foregoing control methods and employs the vertical inversion driving to improve a charging rate, which may be insufficient when applied with different image signals during a display period T.

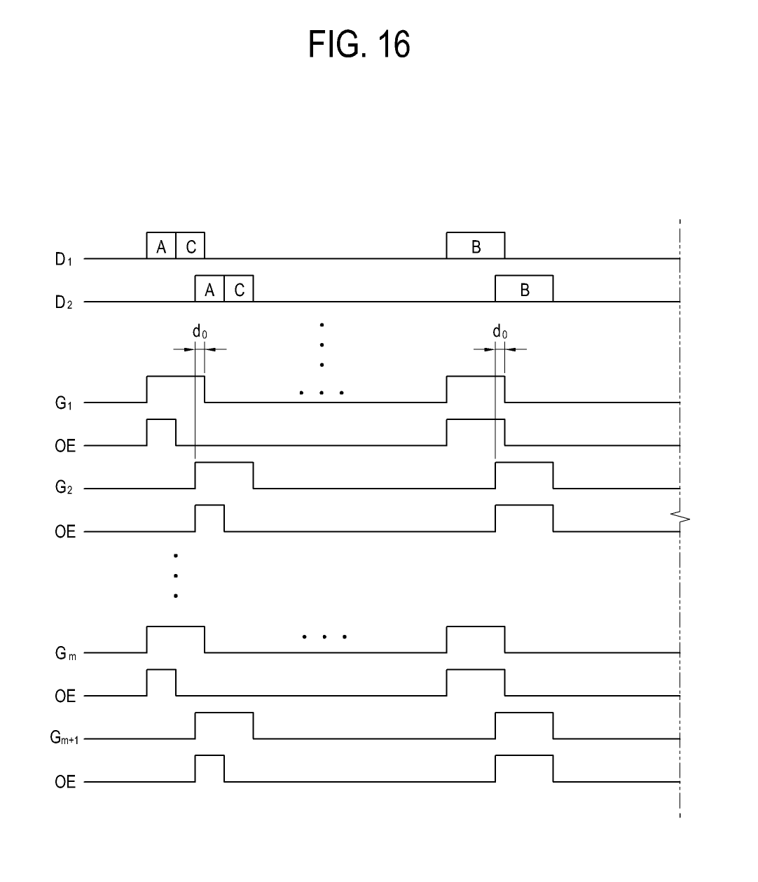

FIG. 16 shows a waveform of a signal to illustrate a control method of the display apparatus of FIG. 15. The waveform of the signal in FIG. 16 is similar to that in FIG. 4. In the present exemplary embodiment, however, gate signals applied to a first gate line G1 and a second gate line G2 overlap with each other for a time d0. In other words, gate signals that overlap with each other are applied to the neighboring pixels I in the column direction. If the overlapped gate signals are applied, a time during which the pixels I are charged with a data voltage may be increased. A driving method using overlapping in the present exemplary embodiment may be used for the foregoing display apparatuses.

If one pixel which has a plurality of sub-pixels includes two or more gate lines, a charging rate may be decreased as the number of gate lines increases. In this case, the display apparatus may adopt the vertical inversion driving and the driving method using overlapping, thereby improving a charging rate.

As described above, exemplary embodiments of the present invention provide a display apparatus that may have improved visibility of moving images and a control method thereof.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a display panel comprising a plurality of pixels; and
a panel driver to receive original image signals corresponding to successive frames, to form an interpolation image signal on the basis of the original image signals corresponding to two successive frames, and to form a non-image signal,
wherein the panel driver applies the original image signal, the interpolation image signal, and the non-image signal to the pixels during a display period of one frame.

2. The display apparatus of claim 1, wherein the pixels comprise:
a gate line;
a data line crossing the gate line; and
a thin film transistor disposed at a crossing area of the gate line and the data line;
the panel driver comprising:
a signal controller to determine a proportion of the original image signal, the interpolation image signal, and the non-image signal to be applied to the pixels during the display period;
a data driver to apply a data voltage selected on the basis of the original image signal, the interpolation image signal, and the non-image signal to the pixels; and
a gate driver to apply a gate signal to the gate lines so that the data voltage is applied to the pixels according to the proportion determined by the signal controller.

3. The display apparatus of claim 2, wherein one of the original image signal and the interpolation image signal is displayed as a first sub-frame of the one frame on the display panel, and the other of the original image signal and the interpolation image signal and the non-image signal are displayed as a second sub-frame of the one frame on the display panel during the display period.

4. The display apparatus of claim 3, wherein the pixels are disposed in a matrix, the gate driver simultaneously applies a gate signal to a first pixel row and a second pixel row, which are spaced apart from each other, during the second sub-frame, and the signal controller outputs a gate enable signal to the gate driver, the gate enable signal to activate the gate signal to apply one of the original image signal and the non-image signal to the first pixel row and to apply the other thereof to the second pixel row.

5. The display apparatus of claim 3, wherein the first sub-frame and the second sub-frame are formed on the display panel for the same amount of time.

6. The display apparatus of claim 3, wherein the first sub-frame is formed on the display panel for a shorter period of time than the second sub-frame.

7. The display apparatus of claim 2, wherein the pixels are disposed in a matrix, the gate driver simultaneously applies a gate signal to a first pixel row, a second pixel row, and a third pixel row, which are spaced apart from each other, during the one frame, and the signal controller outputs a gate enable signal to the gate driver so that the gate signals applied to the first pixel row, the second pixel row, and the third pixel row are not activated at the same time.

8. The display apparatus of claim 7, wherein one of the original image signal, the interpolation image signal, and the non-image signal is applied to the first pixel row, another thereof is applied to the second pixel row, and the other thereof is applied to the third pixel row.

9. The display apparatus of claim 2, wherein neighboring pixels in a column direction are applied with a data voltage with the same polarity.

10. The display apparatus of claim 2, wherein the gate driver applies gate signals to neighboring pixels in a column direction, the gate signals overlapping with each other.

11. The display apparatus of claim 1, wherein the non-image signal comprises a black signal or a gray signal.

12. The display apparatus of claim 1, wherein the display period is 1/60 of a second.

13. The display apparatus of claim 1, wherein the display panel further comprises:
a first substrate;
a second substrate; and
a liquid crystal layer interposed between the first substrate and the second substrate,
wherein the liquid crystal layer comprises liquid crystal molecules aligned in an optically compensated birefringency mode.

14. A control method of a display apparatus that comprises a display panel having a plurality of pixels, the control method comprising:
receiving original image signals corresponding to successive frames;
forming an interpolation image signal on the basis of the original signals corresponding to two successive frames;
forming a non-image signal; and
displaying an image signal where the original image signal, the interpolation image signal, and the non-image signal are applied to the pixels during a display period of one frame.

15. The control method of claim 14, wherein displaying the image signal comprises forming a first sub-frame of the one frame, the first sub-frame being displayed with one of the original image signal and the interpolation image signal, and forming a second sub-frame of the one frame, the second sub-frame being displayed with the other thereof and the non-image signal.

16. The control method of claim 15, wherein the pixels comprise a gate line, a data line, and a thin film transistor disposed at a crossing area of the gate line and the data line, and the display apparatus further comprises a gate driver to apply a gate signal to the gate lines, and
forming the second sub-frame comprises simultaneously applying a gate signal to a first pixel row and a second pixel row, which are spaced apart from each other, and applying one of the original image signal and the non-image signal to the first pixel row and the other thereof to the second pixel row.

17. The control method of claim 14, wherein the pixels comprise a gate line, a data line, and a thin film transistor disposed at a crossing area of the gate line and the data line, and the display apparatus further comprises a gate driver to apply a gate signal to the gate lines, and displaying the image signal comprises:
simultaneously applying a gate signal to a first pixel row, a second pixel row, and a third pixel row, which are spaced apart from each other; and
applying one of the original image signal, the interpolation image signal, and the non-image signal to the first pixel row, another thereof to the second pixel row, and the other thereof to the third pixel row.

18. The control method of claim 14, wherein the display apparatus further comprises a data driver to apply a data voltage selected on the basis of the original image signal, the interpolation image signal, and the non-image signal to the pixels, and displaying the image signal comprises applying a data voltage with the same polarity to neighboring pixels in a column direction.

19. The control method of claim 16, wherein displaying the image signal comprises applying overlapping gate signals to neighboring pixels in a column direction.

20. The control method of claim 14, wherein the non-image signal comprises a black signal or a gray signal.

21. The control method of claim 14, wherein the display period is 1/60 of a second.
